(19) United States
(12) Patent Application Publication
(10) Pub. No.: US 2023/0004928 A1
(43) Pub. Date: Jan. 5, 2023

(54) Order Fulfillment System

(71) Applicant: Levi Strauss & Co., San Francisco, CA (US)

(72) Inventors: Kirsten L'Orange, San Francisco, CA (US); Darsh Balakrishnan, San Jose, CA (US); Andrew Simor, San Francisco, CA (US); Dhivya Rajprasad, Dublin, CA (US); Ignacio de las Heras, Lisbon (PT); Alberto de Santos Sierra, Madrid (ES); Louis DiCesari, London (GB); Ekaterina O. Walsh, Sausalito, CA (US); Navikkumar Modi, Sterrebeek (BE)

(21) Appl. No.: 17/810,278

(22) Filed: Jun. 30, 2022

Related U.S. Application Data
(60) Provisional application No. 63/202,944, filed on Jun. 30, 2021.

(51) Int. Cl. G06Q 10/08; G06Q 30/02

(52) U.S. Cl. CPC G06Q 10/087; G06Q 30/0202

(57) ABSTRACT

An order fulfillment system receives electronic or online orders from customers and fulfills these by selecting from facilities such as retail stores and distribution centers to ship the items to complete the orders. The system determines which facility to ship from by maximizing profitability and minimizing split shipments. The system allocates orders to facilities while considering margin and preventing excessive numbers of split shipments, which reduces margin due to shipping costs. Further, the system can allocate products that are on promotion (e.g., markdown) or approaching promotion in a retail store to an online order, thus increasing margins. The system can help prevent the buildup of inventory gluts of unproductive products within a store. The system includes a profitability forecast component and in particular, can predict of the future selling price by location or channel, or a combination.

### CROSS-REFERENCE TO RELATED APPLICATIONS

This patent application claims the benefit of U.S. patent application 63/202,944, filed Jun. 30, 2021, which is incorporated by reference along with all other references cited in this application.

### DESCRIPTION

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

This invention relates to electronic commerce or e-commence and, more specifically, to the fulfillment of orders placed online, where the orders are fulfilled by inventory at retail stores or distribution centers, or a combination.

In 1853, during the California Gold Rush, Levi Strauss, a 24-year-old German immigrant, left New York for San Francisco with a small supply of dry goods with the intention of opening a branch of his brother's New York dry goods business. Shortly after arriving in San Francisco, Mr. Strauss realized that the miners and prospectors (called the “forty niners”) needed pants strong enough to last through the hard work conditions they endured. So, Mr. Strauss developed the now familiar jeans which he sold to the miners. The company he founded, Levi Strauss & Co. or LS&Co., still sells jeans and is the most widely known jeans brand in the world. Levi's is a trademark of Levi Strauss & Co.

Though jeans at the time of the Gold Rush were used as work clothes (which were relatively loose fitting since fashion was not a concern), jeans have evolved to be fashionably worn everyday by men and women, showing up on billboards, television commercials, and fashion runways. Fashion is one of the largest consumer industries in the U.S. and around the world. Jeans and related apparel are a significant segment of the industry.

With the widespread success of the Internet, more and more orders for jeans and other apparel are being placed online, through Web, mobile apps, and other e-commerce channels. Further, an increase of online orders was evidenced during the 2020 coronavirus pandemic, when retail stores were mandated to be closed to prevent the spread of the virus. Despite the success of online commerce of apparel, the profitability of an order can be vary greatly depending on how an order is split for fulfillment by multiple stores or facilities, shipping cost, lost opportunity cost by fulfilling an item from a store, and other factors.

Therefore, there is a need for an improved order fulfillment system, especially where this system increase profitability and reduces a number of splits.

### BRIEF SUMMARY OF THE INVENTION

An order fulfillment system receives electronic or online orders from customers and fulfills these by selecting from facilities such as retail stores and distribution centers to ship the items to complete the orders. The system determines which facility to ship from by maximizing profitability and minimizing split shipments. The system allocates orders to facilities while considering margin and preventing excessive numbers of split shipments, which reduces margin due to shipping costs. Further, the system can allocate products that are on markdown or approaching markdown in a retail store to an online order, thus increasing margins. The system can help prevent the buildup of inventory gluts of unproductive products within a store. The system includes a profitability forecast component and in particular, can predict of the future selling price by location or channel, or a combination.

In an implementation, a method includes: receiving an order online created by a customer at an order fulfillment server, where the order can be fulfilled by shipment of two or more package from a plurality of retail stores or a distribution center, or a combination; generating an order fulfillment plan by determining a first subset of retail stores that have a capacity to fulfill the order, of the first subset, determining a second subset of retail stores which can fulfill an order based an inventory of the retail store and an inventory protection value for the retail store, determining that to fulfill the order, the order will be split among the second subset of retail stores and distribution center, for each retail store of the second subset, calculating an earnings before income and taxes (EBIT) for each item in the order; selecting one or more retail store to fulfill the order to increase earnings before income and taxes while at the same time reducing shipping costs due to splitting the order into two or more packages; and based on the order fulfillment plan, shipping items in the order to the customer in multiple packages, where at least one of a first package is from a first retail store of the retails stores and a second package is from the distribution center, or a third package is from the first retail store and a fourth package is from a second retail store.

In an implementation, a method includes: providing a first pair of jeans, where the first pair of jeans includes a first product; providing a second pair of jeans, where the second pair of jeans includes a first product; providing a third pair of jeans, where the third pair of jeans includes a second product; providing a first retail store at a first location, where the first retail store includes floor space designated for displaying products and selling product directly to customers who shop at the first retail store; providing a second retail store at a second location, where the second retail store includes floor space designated for displaying products and selling products directly to customers who shop at the second retail store, and the second location is different from the first location; and providing a distribution center a third location, where the distribution center stores products to be shipped to retail stores to replenish inventory at the retail stores and to fulfill online orders, an online order is an order that is created online, and the third location is different from the first and second locations.

The method further includes: receiving an online order at an order fulfillment server including a request for the first product and a request for the second product, where the online order was created by a customer at a fourth location, and the fourth location is different from the first, second, and third locations; and at the order fulfillment server, making a determination of whether the first retail store or second retail store will be used to fulfill the request for the first product of the online order, and that the distribution center will be used to fulfill the request for the second product.

The method further includes: determining a first cost by performing a first cost calculation of fulfilling the request for the first product of the online order via the first retail store, where the first cost is based on a future earnings before income and taxes and a determination is made that the first product will be sold at a discount at a time period in the future; determining a second cost performing a second cost calculation of fulfilling the request for the first product of the online order via the first retail store, the second cost is based on a future earnings before income and taxes and a determination is made that the first product will not be sold at a discount in the time period in the future; and determining the first cost is less than the second cost.

The method further includes: creating a fulfillment plan where a first package will include the first product from the first retail store, and the first package will be sent to the customer to fulfill the online order, and a second package will include the second product from the distribution center, the second package is separate from the first package, and the second package will be sent to the customer to fulfill the online order.

In an implementation, a system includes: a number of facilities available to fulfill an order including a first retail store including a first inventory of a first product and no inventory of a second product, a second retail store including a second inventory of the first product and no inventory or the second product, and a first distribution center including no inventory of the first product and a first inventory of a second product; and an order fulfillment server, receiving an first order via an online channel (e.g., from a mobile device or a Web browser).

Further, the first order includes a first quantity of the first product and a second quantity of the second product, and the first order is to be fulfilled by splitting the first order across two or more facilities. The order fulfillment server calculates a first earnings before income and taxes (EBIT) for fulfilling the first product through the first retail store. The order fulfillment server calculates a second earnings before income and taxes (EBIT) for fulfilling the first product through the second retail store, where the first EBIT is greater than the second EBIT. The order fulfillment server fulfills the first order by routing the second quantity of the second product to the first distribution center and due to the first EBIT being greater than the second EBIT, and routing the first quantity of the first product to the first retail store instead of the second retail store.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a simplified block diagram of a client-server system and network in which an e-commerce and order fulfillments system can be implemented.

FIG. 2 shows a more detailed diagram of an exemplary client or server computer of the system.

FIG. 3 shows a system block diagram of a computer.

FIG. 4 shows a system diagram of an order fulfillment system.

FIG. 5 shows a two-stage implementation of an order fulfillment system.

FIG. 6 shows a flow diagram of a technique of an order fulfillment system.

FIG. 7 shows a flow diagram of a technique of inventory protection logic.

FIG. 8A shows flow of a technique of EBIT forecast optimization.

FIG. 8B shows an alternative flow of a technique of EBIT forecast optimization.

FIG. 9 shows a block diagram of manual business overrides of the order fulfillment system.

### DETAILED DESCRIPTION OF THE INVENTION

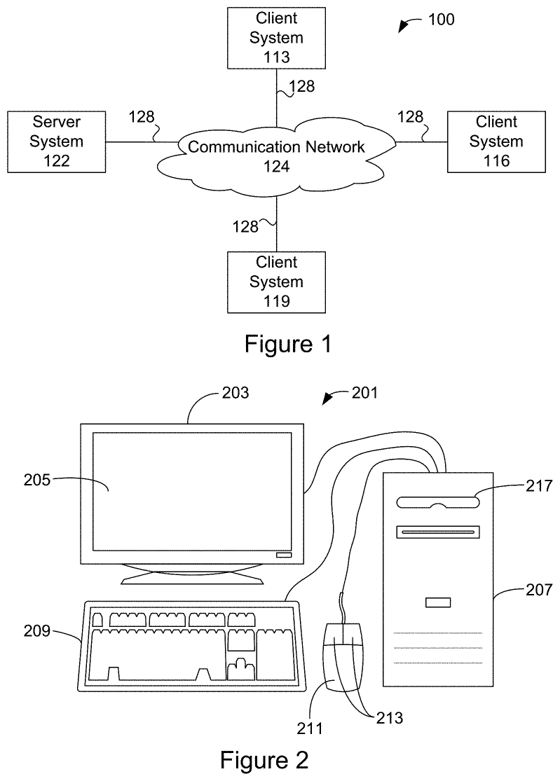

FIG. 1 is a simplified block diagram of a distributed computer network 100 in which an e-commerce and order fulfillments system can be implemented. Computer network 100 includes a number of client systems 113, 116, and 119, and a server system 122 coupled to a communication network 124 via a plurality of communication links 128. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Communication links 128 may be DSL, Cable, Ethernet or other hardwire links, passive or active optical links, 3G, 3.5G, 4G and other mobility, satellite or other wireless communications links, wave propagation links, or any other mechanisms for communication of information.

Various communication protocols may be used to facilitate communication between the various systems shown in FIG. 1. These communication protocols may include VLAN, MPLS, TCP/IP, Tunneling, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, an intranet, a private network, a public network, a switched network, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both as a client or a server depending on whether the computer system is requesting or providing information. Additionally, although aspects of the invention have been described using a client-server environment, it should be apparent that the invention may also be embodied in a stand-alone computer system.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

Client systems 113, 116, and 119 enable users to access and query information stored by server system 122. In a specific embodiment, the client systems can run as a standalone application such as a desktop application or mobile smartphone or tablet application. In another embodiment, a “web browser” application executing on a client system enables users to select, access, retrieve, or query information stored by server system 122. Examples of web browsers include the Internet Explorer and Edge browser programs provided by Microsoft Corporation, Firefox browser provided by Mozilla, Chrome browser provided by Google, Safari browser provided by Apple, and others.

In a client-server environment, some resources (e.g., files, music, video, or data) are stored at the client while others are stored or delivered from elsewhere in the network, such as a server, and accessible via the network (e.g., the Internet). Therefore, the user's data can be stored in the network or “cloud.” For example, the user can work on documents on a client device that are stored remotely on the cloud (e.g., server). Data on the client device can be synchronized with the cloud.

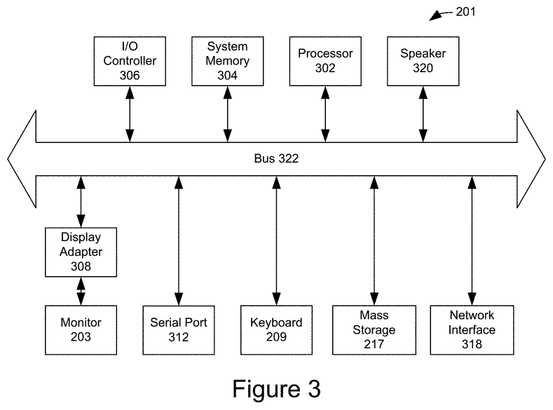

FIG. 2 shows an exemplary client or server system. In an embodiment, a user interfaces with the system through a computer workstation system, such as shown in FIG. 2. FIG. 2 shows a computer system 201 that includes a monitor 203, screen 205, enclosure 207 (may also be referred to as a system unit, cabinet, or case), keyboard or other human input device 209, and mouse or other pointing device 211. Mouse 211 may have one or more buttons such as mouse buttons 213.

It should be understood that the present invention is not limited any computing device in a specific form factor (e.g., desktop computer form factor), but can include all types of computing devices in various form factors. A user can interface with any computing device, including smartphones, personal computers, laptops, electronic tablet devices, global positioning system (GPS) receivers, portable media players, personal digital assistants (PDAs), other network access devices, and other processing devices capable of receiving or transmitting data.

For example, in a specific implementation, the client device can be a smartphone or tablet device, such as the Apple iPhone (e.g., Apple iPhone 12 and iPhone 12 Pro), Apple iPad (e.g., Apple iPad Air, Apple iPad Pro, or Apple iPad mini), Apple iPod (e.g., Apple iPod Touch), Samsung Galaxy product (e.g., Galaxy S series product or Galaxy Note series product), Google Nexus, Google Pixel devices (e.g., Google Pixel 5), and Microsoft devices (e.g., Microsoft Surface tablet). Typically, a smartphone includes a telephony portion (and associated radios) and a computer portion, which are accessible via a touch screen display.

There is nonvolatile memory to store data of the telephone portion (e.g., contacts and phone numbers) and the computer portion (e.g., application programs including a browser, pictures, games, videos, and music). The smartphone typically includes a camera (e.g., front facing camera or rear camera, or both) for taking pictures and video. For example, a smartphone or tablet can be used to take live video that can be streamed to one or more other devices.

Enclosure 207 houses familiar computer components, some of which are not shown, such as a processor, memory, mass storage devices 217, and the like. Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive or solid state drive (SSD)), battery-backed-up volatile memory, tape storage, reader, and other similar media, and combinations of these.

A computer-implemented or computer-executable version or computer program product of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software of the present invention may also be stored or reside on mass storage device 217 (e.g., hard disk, magnetic disk, tape, or CD-ROM). As a further example, code of the invention may be transmitted via wires, radio waves, or through a network such as the Internet.

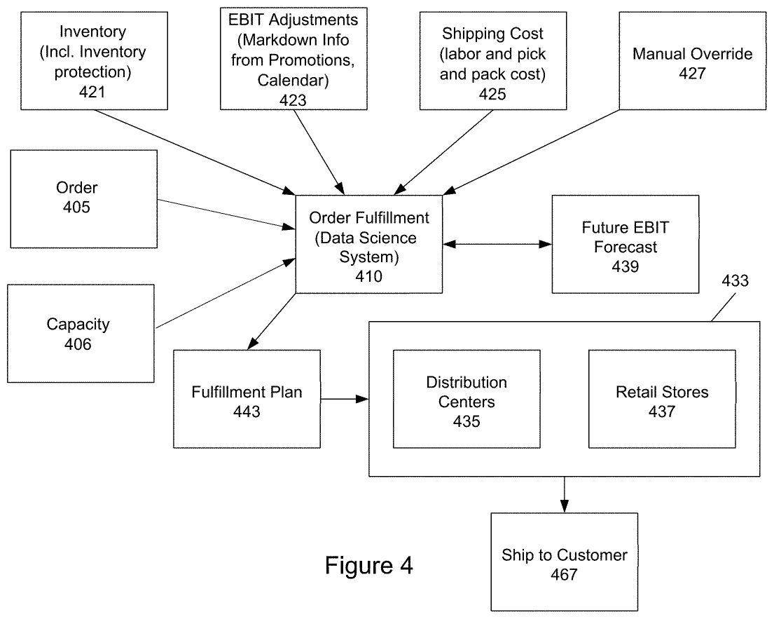

FIG. 3 shows a system block diagram of computer system 201 used to execute the software of the present invention. As in FIG. 2, computer system 201 includes monitor 203, keyboard 209, and mass storage devices 217. Computer system 501 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, Matlab (from MathWorks), SAS, SPSS, JavaScript, AJAX, Java, Python, Erlang, and Ruby on Rails. The computer software product may be an independent application with data input and data display modules. Alternatively, the computer software products may be classes that may be instantiated as distributed objects. The computer software products may also be component software such as Java Beans (from Oracle Corporation) or Enterprise Java Beans (EJB from Oracle Corporation).

An operating system for the system may be one of the Microsoft Windows® family of systems (e.g., Windows 95, 98, Me, Windows NT, Windows 2000, Windows XP, Windows XP x64 Edition, Windows Vista, Windows 7, Windows 8, Windows 10, Windows 11, Windows CE, Windows Mobile, and Windows RT), Symbian OS, Tizen, Linux, HP-UX, UNIX, Sun OS, Solaris, Mac OS X, Apple iOS, Android, Alpha OS, AIX, IRIX32, or IRIX64. Other operating systems may be used. Microsoft Windows is a trademark of Microsoft Corporation.

Any trademarks or service marks used in this patent are property of their respective owner. Any company, product, or service names in this patent are for identification purposes only. Use of these names, logos, and brands does not imply endorsement.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (e.g., IEEE standards 802.11, 802.11a, 802.11b, 802.11e, 802.11g, 802.11i, 802.11n, 802.11ac (e.g., Wi-Fi 5), 802.11ad, 802.11ax (e.g., Wi-Fi 6), and 802.11af, just to name a few examples), near field communication (NFC), radio-frequency identification (RFID), mobile or cellular wireless (e.g., 2G, 3G, 4G, 5G, 3GPP LTE, WiMAX, LTE, LTE Advanced, Flash-OFDM, HIPERMAN, iBurst, EDGE Evolution, UMTS, UMTS-TDD, 1×RDD, and EV-DO). For example, signals from a computer may be transferred, at least in part, wirelessly to components or other computers.

In an embodiment, with a web browser executing on a computer workstation system, a user accesses a system on the World Wide Web (WWW) through a network such as the Internet. The web browser is used to download web pages or other content in various formats including HTML, XML, text, PDF, and postscript, and may be used to upload information to other parts of the system. The web browser may use uniform resource identifiers (URLs) to identify resources on the web and hypertext transfer protocol (HTTP) in transferring files on the web.

In other implementations, the user accesses the system through either or both of native and nonnative applications. Native applications are locally installed on the particular computing system and are specific to the operating system or one or more hardware devices of that computing system, or a combination of these. These applications (which are sometimes also referred to as “apps”) can be updated (e.g., periodically) via a direct internet upgrade patching mechanism or through an applications store (e.g., Apple iTunes and App store, Google Play store, Windows Phone store, and Blackberry App World store).

The system can run in platform-independent, nonnative applications. For example, client can access the system through a web application from one or more servers using a network connection with the server or servers and load the web application in a web browser. For example, a web application can be downloaded from an application server over the Internet by a web browser. Nonnative applications can also be obtained from other sources, such as a disk.

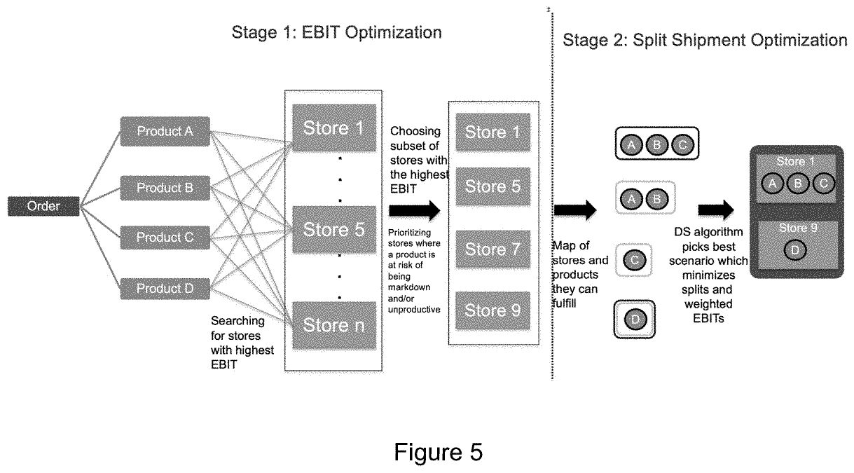

FIG. 4 shows a system diagram of an order fulfillment system (OFS). The order fulfillment system may also be referred to as a routing and margin optimization (RMO), routing and margin benefit optimization (RAMBO), or ship from store (SFS) system or engine. An order fulfillment system may also be referred to as an order management system (OMS).

An order 405 such as an e-commerce order is received via the Internet or other network from a customer. This order is sent to an order fulfillment block 410 (which can also be referred as a data science (DS) system), which handles determining how to fulfill the order.

To fulfill the order, some inputs to the order fulfillment block include an inventory input 421 (e.g., including inventory protection), EBIT adjustments input 423, shipping cost input 425, and manual override input 427. The inventory input provides the availability of each item of the order at each of facilities 433 of the company. The facilities can include distribution centers 435 and retail stores 437.

In addition, the categories of data sources as input to the order fulfillment system are summarized in table A.

TABLE A

| Category | Attributes | Source | Notes |
|---|---|---|---|
| Inventory | Available | Somewhat | The quantity |
| | quantity; | delayed | available for |
| | Inventory | inventory | a SKU |
| | protection | from store | has inventory |
| | value | (e.g., 5 to | protection value |
| | | 15 minute | deducted |
| | | delay) | |
| Capacity | Utilized | Somewhat | Can go up |
| | capacity | delayed | to, e.g., 20 |
| | of a store | from store | percent over |
| | | (e.g., 5 to 15 | a store's |
| | | minute delay) | capacity |
| Shipment | Zip to zip | FedEx, USPS | Default values |
| Cost | flat rate | | imputted for |
| | | | shipment weight |
| | | | and package size |
| | | | (e.g., actual |
| | | | shipment costs |
| | | | are inferred |
| | | | based on |
| | | | shipment |
| | | | weight and |
| | | | package size) |
| Labor Cost | Static differing | | Different rate for |
| | by distribution | | stores and |
| | centers (DCs) | | DCs based |
| | and stores | | on location |
| | costs based on | | |
| | fulfillment | | |
| Pick and | Blended static | | Can use a static rate |
| Pack Cost | cost of picking | | based on DCs. Can |
| | from storage | | include a rate for |
| | and packing | | stores too |
| Markdown | Prices | Assortment | Inferring |
| Information | from stores' | tools | markdown |
| | markdown | | status from price |
| | calendar | | information |
| Unproductive | Unproductive | Current | Weekly sellout |
| Products | status, weeks | inventory and | calculated through |
| | on hand | historical sales | end of most recent |
| | | | fiscal week |

EBIT refers to earning before income and taxes (EBIT), and is a measure of profitability. The EBIT adjustments input describes the adjustments to the EBIT or profitability of fulfilling an order, with adjustments dues to factors like a promotions calendar (e.g., calendar or upcoming discounts and sales).

Shipping cost input 425 is a measure of the shipping cost for shipping an item to the customer's location or shipping address. Additional costs considered here may include labor costs and pick and pack costs.

Manual override input 427 is an optional feature of the order fulfillment system that allows an administrator to specify, such as by way of a template, of how orders will be fulfilled. For example, using the manual override feature, an administrator can have the order fulfillment system select a specific facility to fulfill orders under particular conditions (e.g., customer located geographically closed to a distribution center). The manual override functionality is included in the system so that the system can handle or incorporate business overrides based on criteria outside the core approach or technique.

Other input variables include a capacity limit 408 (e.g., an upper limit or a limit value somewhat less than this upper limit) within stores, and access to the relevant data sources and files which are stored as an environment variable within the codebase. A system administrator can easily control and update these variables.

Using these inputs, the order fulfillment system generates a future EBIT forecast 439 for each item in the order, a predicted profit value for the last unit sold at a certain facility. The calculated EBIT values are future or forecasted values, given the input such as the EBIT adjustments due to discounts or promotions. Based on the future EBIT forecast, the order fulfillment system generates a fulfillment plan 443 based on EBIT. For example, order fulfillment system can fulfill orders based on maximizing or increasing EBIT.

Then, the fulfillment plan is sent to the facilities, where the order is picked and packed and shipped to the customer 467.

In an implementation, an item gets shipped from a store if it was not available in distribution center or other factors such as faster shipment (e.g., store being nearer to customer), improved EBIT margin, or a combination. This notification to store is given by, e.g., a mobile app to fulfill the order and the chosen criteria of store is its location (e.g., near to customer). As a constraint, a store can fulfill 50 to about 500 max items (configurable by store; e.g., up to a store's maximum fulfillment capacity limit) in a day. There are no limits on the number of DC shipments in a day. There is an option to decide how many orders a store can take in a day, and on hitting that capacity, the store goes offline. As ecommerce sales continue to grow, stores items are getting fulfilled by online orders, so store fulfillment can be from about 400 to 4000 items a day. There are some problems for online shipments.

Split Shipment: If, for example, the order contains five items out of which three are available in DC and rest two are fulfilled from two different stores, then shipment costs associated with each item fulfilled from different location increases the overall shipment cost for an order. Note that shipment may be free or cheap for customers, but its additional cost to the company.

Margin: There is a price difference between the items being sold on stores versus online. In most cases, the online price of an item tends to be less than that in stores. So for example: We can look an item that costs $40 to produce and sell. A store can tag that item to sell at $100, making a profit margin of $60. However, if that product is available online at $50, it may be fulfilled by that same store after the distribution center become out of stock. In this case, the store now only makes a $10 margin compared to the original $60, while occurring an additional shipment cost, further reducing margin.

To prevent or minimize the impact on lowering store margin, the order fulfillment system attempts to reduce the number of split shipments and considers the costs of an item to maximize margin for each shipment. The order fulfillment system uses a model to select a specific store or stores where an order is margin optimized.

Some data factors for the order fulfillment system include inventory data and capacity data.

Inventory Data: This is further divided into three categories:

1. Perpetual: This represents how much inventory the company has at a certain location of some SKU (product, size, and color) exactly.

2. Inventory Protection: This is the safety stock that the store would like to keep on its store floor and not expose to online customers.

3. Availability: Total available quantity across the company network (DC+Stores)-Against which orders are taken online from the Web site. So, availability comes into picture when someone orders online, and the system after receiving that order checks how much is available and where, and it allocates that order to fulfill from a store.

Capacity Data: This represents how many orders can a store take in a given day. This can be a rolling number). This can be a unit count not order count. Once capacity is full, then the entire store goes offline.

Below is an example of an allocation flow by the order fulfillment system. A table B lists an order. A table C provides and abbreviated list of an inventory picture for the order in table B. A table D lists an allocation or fulfillment decision for two sample fulfillment plans.

TABLE B

| Item Name | Units | E-Commerce Price |
|---|---|---|
| 511 Men's Jeans | 1 | $48.65 |
| 314 Women's Jeans | 1 | $49.99 |

TABLE C

| Item Name | Facility Name | Quantity Available |
|---|---|---|
| 511 Men's Jeans | Seattle Premium Outlet Store | 4.00 |
| 511 Men's Jeans | Milpitas Outlet Store | 3.00 |
| 314 Women's Jeans | Laughlin Outlet Store | 3.00 |
| 314 Women's Jeans | Seattle Premium Outlet Store | 2.00 |
| 314 Women's Jeans | Henderson Distribution | 24.00 |
| | Center | |

TABLE D

| | | | Order |
|---|---|---|---|
| | Order Fulfillment | | Fulfillment |
| | Plan 1 | | Plan 2 |
| Facility | Milpitas | Henderson | Seattle |
| | Outlet | Distribution | Premium |
| | Store | Center | Outlet Store |
| Item Name | 511 Men's | 314 Women's | 511 Men's |
| | Jeans | Jeans | Jeans |
| | | | 314 Women's |
| | | | Jeans |

| | | |
|---|---|---|
| Number of | 2 | 1 |
| Shipments | | |
| Total Cost | $26.13 | $11.69 |
| Total Price | $98.64 | $98.64 |
| EBIT | $72.51 | $86.95 |

In table D, the EBIT for order fulfillment plan 1 is $72.51, while for order fulfillment plan 2 is $86.95. For the total cost, the order fulfillment system also uses shipping information (e.g., FedEx shipping rates) and pick and pack rates in order to optimize the results. Between these two plans, the order fulfillment system selects order fulfillment plan 2 over order fulfillment plan 1 since the EBIT is greater. Order fulfillment plan 1 has a higher total cost due higher shipping cost because the order has been split into two packages, instead of one. Thus, the order fulfillment system has fulfilled the order while increasing profitability.

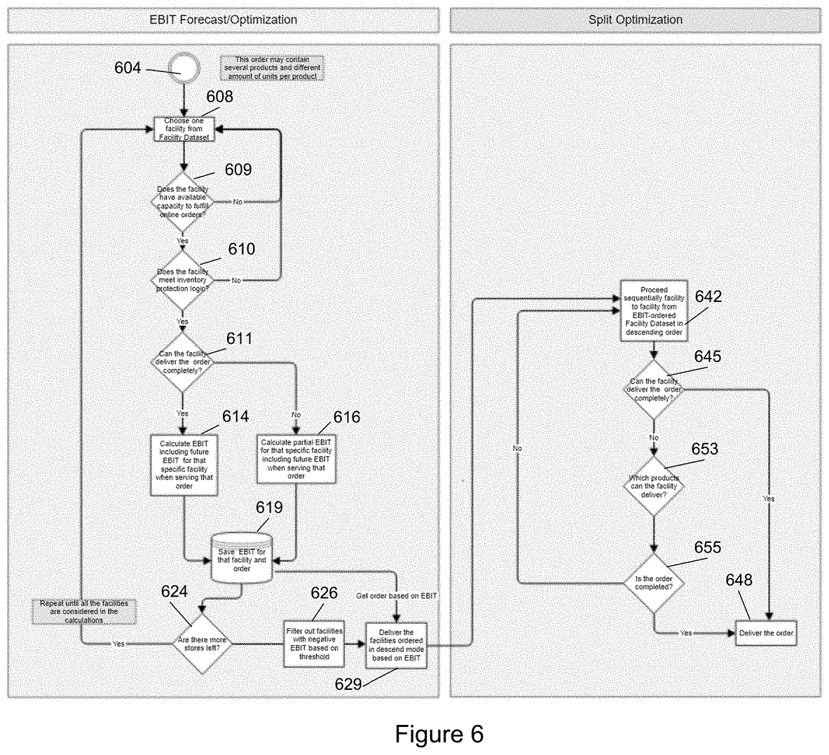

FIG. 5 shows an implementation of an order fulfillment system having two stages. In a first stage, EBIT is optimized. In a second stage, split shipment is optimized.

In the first stage, an order of a number of items, such as products A, B, C, and D, is received. Some products can include apparel including jeans, shirts, shorts, jackets, vests, and skirts, to obtain a faded, distressed, washed, or worn finish or appearance. These products can be made of denim, cotton, and blends of cotton and nylon or cotton and polyester.

The order fulfillment system searches for stores (e.g., retail stores, stores 1, 2, 3, to n and distribution centers (not shown)) with the highest EBIT. Retail stores have floor space for customers who shop at the store to see and try on the garments and other products being sold there. After the search, the order fulfillment system selects a subset of the stores with the highest EBIT. The order fulfillment system prioritizes stores where a product is at a risk of being markdown or being unproductive. For example, the subset of stores can be stores 1, 5, 7, and 9.

After the first stage, the processing proceeds to the second stage. The second stage creates a map of stores and products they can fulfill. The order fulfillment system (e.g., data science technique) picks the best scenario in which minimizes splits and weighted EBIT (e.g., minimizes the splits while maximizing or increasing or improving a total EBIT of an order). For example, the second stage determines that products A, B, and C will be fulfilled by store 1, while product D will be fulfilled by store 9.

This application describes some flows. It should be understood that the invention is not limited to the specific flows and steps presented. A flow of the invention may have additional steps (not necessarily described in this patent), different steps which replace some of the steps presented, fewer steps or a subset of the steps presented, or steps in a different order than presented, or any combination of these. Further, the steps in other implementations of the invention may not be exactly the same as the steps presented and may be modified or altered as appropriate for a particular application or based on the data or situation.

This application describes some examples of implementations with specific values or times (e.g., number of units or weeks). These are not intended to be exhaustive or to limit the invention to the precise form described. These values can vary due to, for example, various factors. For example, the values can vary plus or minus 2 percent, plus or minus 5 percent, plus or minus 8 percent, plus or minus 10 percent, plus or minus 15 percent, or plus or minus 20 percent. Values can be greater (e.g., a lower bound) or lower than those described (e.g., an upper bound).

The values are for a specific implementation, and other implementations can have different values, such as certain values made larger or smaller. The value may be made proportionally larger or smaller by adjusting values proportionally (e.g., maintaining the same or about the same ratio between different values). In various implementations, the values can be the same as the value given, about the same of the value given, at least or greater than the value given, or can be at most or less than the value given, or any combination of these.

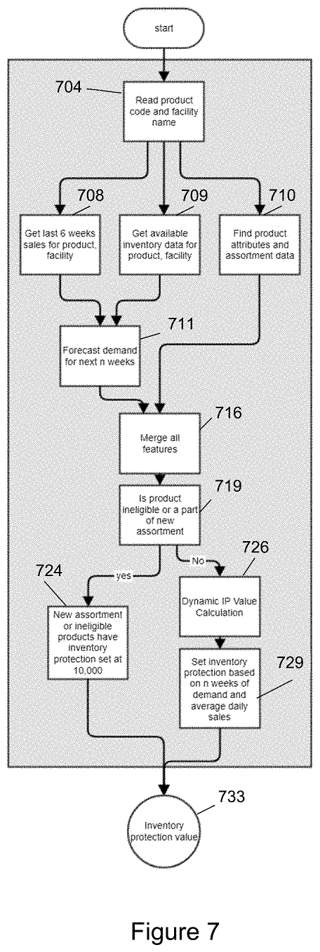

FIG. 6 shows a flow diagram of a technique of an order fulfillment system. This flow is a two-stage implementation, where the EBIT forecast or optimization is a first stage, and a split optimization is a second stage.

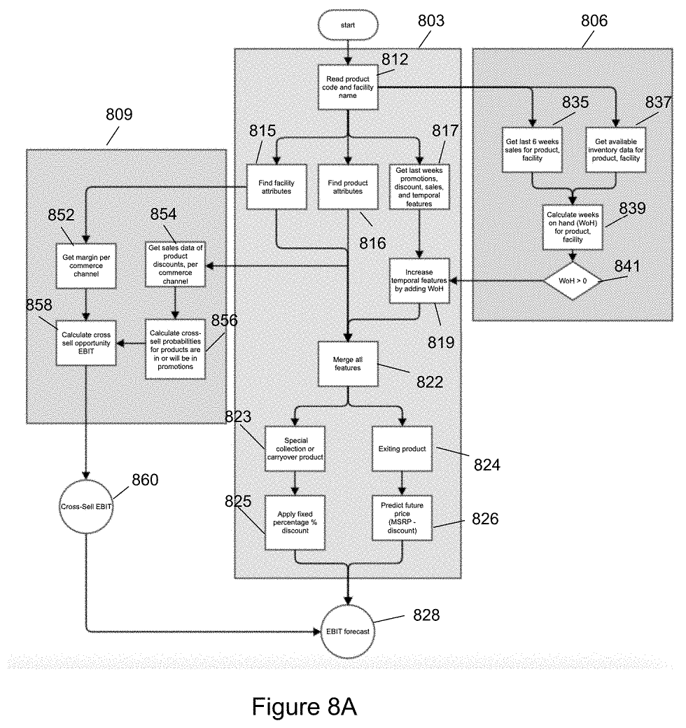

In the first stage of the flow, an order 604 is received. This order may contain several products and a different amount of units per product. In a block 608, the flow chooses one facility form a facility dataset. Decision block 609 determines whether the facility has available capacity requirements to fulfill online orders from the facility. Decision block 610 determines whether the inventory the facility on hand meets inventory protection logic. FIG. 7 and its accompanying discussion below provide more details of block 610. A decision block 611 determines whether the facility can deliver the order completely. If yes, the flow proceeds to block 614 to calculate EBIT including future EBIT for that specific facility when serving that order. If no, the flow proceeds to block 616 to calculate a partial EBIT including future EBIT for that specific facility when serving that order. After blocks 614 and 616, the flow proceeds to block 619, which saves the EBIT for that facility and order in a storage location.

In an implementation, the data for EBIT for each facility-ordered item combination is only kept for the purposes of allocation for that particular order. Once the allocation is performed, the system does not store the EBIT data for the items or facilities within the order.

The flow proceeds to decision block 624 to determine whether there are more stores left to calculate an EBIT for. If yes, the flow proceeds in a loop back to block 608. This loop repeats until all the facilities are considered in the calculations. If no, the flow proceeds to block 626 to filter out facilities with negative EBIT based on threshold. The flow proceeds to block 629, deliver the facilities orders in descend mode based on EBIT (e.g., sorted from highest to lowest EBIT). Block 629 can access the storage 619 to get the order based on EBIT. From block 629, the flow proceeds to the second stage of the flow.

In the second stage of the flow, block 629 (from the first stage) proceeds to block 642, proceed sequentially facility to facility from the EBIT-ordered facility dataset in descending order. The flow proceed to decision block 645 to determine whether the facility deliver the order completely. If yes, proceed to block 648 and deliver the order. If no, proceed to decision block 653 to determine which products the facility can deliver.

The flow proceeds to decision block 655 to determine is the order is completed. If yes, the flow proceeds to block 648. If no, the flow loops back to block 642 and continues to loop until the order is completed.

In the split optimization, a weighting for each of the products within each of the facilities is based on the EBIT that can be obtained for each of them. The choice of facility is based on which facility or set of facilities can provide the highest EBIT for the order. This is carried out by an exponential decay function. A reason to split an order is when every item is not completely available in one facility.

The EBIT value is computed for every item-facility combination can be thought of as being similar to a pivot table. In an implementation, this is accomplished through the constraints in the linear programming approach. An important constraint is that the stores which are picked have sufficient inventory to be able to successfully fulfill an order. The EBIT ordered list has facilities for which inventory (full or partial) are present for the items within the order. It is placed into a decay function.

FIG. 7 shows a flow diagram of a technique of inventory protection logic. This flow takes inventory data to forecast demand, and then sets inventory protection values for each facility based on current business product assortment goals and a dynamic inventory value calculation. This flow provides more detail of block 610 of FIG. 6.

In the inventory protection flow, for an order, a block 704 reads product code (e.g., PC13 code) and facility name. The order fulfillment system gathers the last 6 weeks of sales for the products at facilities in 708, available inventory at facilities in 709, and product attribute and assortment data in 710 (e.g., based on PC9 code). In block 711, the order fulfillment system utilizes sales history and available inventory to forecast demand for the next n amount of weeks (e.g., n can be 4). Here, the order fulfillment system is able to account for situations where the facilities were out of stock in evaluating demand.

From blocks 711 and 710, the flow proceeds to a block 716 (merge all features). After merging all the features, products are evaluated for eligibility based on product features and current product assortment in block 719. If product is ineligible or new assortment, product is given a high inventory protection value in block 724 to prevent orders utilizing that product inventory. Otherwise, a dynamic IP value calculation is done in block 726, calculating the ratio between forecasted demand and historical demand as a coefficient to adjust inventory protection values to account for expected fluctuations in demand. This coefficient to set inventory protection values for products in block 729. Blocks 724 and 729 are then able to arrive at inventory protection values for products at each facility in block 733. In an implementation, blocks 704, 708, 709, 711, 716, 719, 724, 726, and 729 use PC9-type product codes, while block 710 uses PC13 codes.

In an implementation, the inventory protection flow is a scheduled job that executes three times in a day. For example, the job may execute at 7 a.m., 1 p.m., and 7 p.m., or other schedule. This allows updating inventory protection value based on the sales and inventory data of the store. The inventory protection flow is used for retail store facilities and the like, and generally not for distribution centers. There can be any number of scheduled inventory checks, more than 3 or less than 3. In another implementation, the inventory protection flow is automatically triggered when an event occurs at a facility, such as a sale or a inventory change event.

For a store, block 708 gathers 6 weeks of sales for a product at a facility. The number of weeks can be a value I, where I is an integer 1 or greater. For example, week 1 may have sales of 5, week 2 may have sales of 4, week 3 may have sales of 6, week 4 may have sales of 1, week 5 may have sales of 2, and week 6 may have sales of 2. An average value can be calculated, such as 3.3 for the above example.

Block 709 gathers 6 weeks of inventory data for the product at the facility. The number of weeks can be a value J, where J is an integer 1 or greater. Typically, I and J are the same value. The inventory data gives inventory (e.g., number of units available for sale) after sales of the product (either at the store or online) and replenishment of the product. For example, week 1 may have an inventory of 10, week 2 may have an inventory of 7, week 3 may have an inventory of 2, week 4 may have an inventory of 7, week 5 may have an inventory of 7, and week 6 may have an inventory of 3. An average value can be calculated, such as 6 for the above example.

Using the sales data 708 and inventory data 710, block 711 determines a forecast of demand for the next K weeks (based on historical data), where K is an integer 1 or greater. In an implementation, K is 4, which is less than I and J. But in other implementations, K can be any integer value. K can be the same as I or J, or both. K can be less than I or J, or both. Or, K can be more than I or J, or both. For example, for each week of the 4 weeks, for the example, the sales can be 3.3 (or truncated value of 3 can be used) and inventory of 6 (or truncated value can be used if not an integer value), which are based on the average values.

In an implementation, the flow through to block 711 can be used to find a calculated forecasted demand based on historical data, and this value is used as the inventory protection value or the inventory protection value is based on this forecasted demand value. So for same values given above, the inventory protection value can be set to 4, which would be 2 less than the calculated average value of 4. The inventory would still be more than the average sales of 3 per week for the next 4 weeks. So as long as the inventory remains 4 or above, then this store can be selected.

In an implementation, there can also be a minimum inventory protection value, such as 1, 2, 3, or 4, or other value. When the calculated forecasted demand based on historical data from block 711 is below the minimum inventory protection value, then the minimum inventory protection value can be used instead. This minimum inventory protection value can be used to ensure a certain amount of inventory remains in the store, to satisfy retail orders. Also, this inventory protection value (e.g., minimum inventory protection value or inventory protection value from forecasted demand of block 710) can be used to reduce the possibility of assigning an e-commerce or online order to a store and then during the time period before the order is fulfilled or picked by the store, that the inventory has already been sold at the store at retail.

For the blocks 710, 716, and after, these handle making adjustments to the inventory protection value based on other factors, such as future expected future demand or the product being a new product. Block 710 gathers product attributes and assortment data for the product. Then block 716 merges or combines the forecasted demand (from block 711) and product attributes and assortment data together.

In block 710, some attributes of a product might be when a product was first introduced and the type of product. These can be used to determine a new product. There can be types of products: Core products are those that are carried across multiple selling seasons (e.g., classic 501 jeans). Seasonal products are those that are carried perhaps for only a single season (e.g., winter or summer items). In a year, there might be two seasons, each 6 months in length, such as spring and summer, and fall and winter, or alternatively, winter and spring, and summer and fall.

For the first X weeks (e.g., 6 weeks) after a seasonal product is introduced, it may be desirable to prevent that product from being taken from the retail stores and sold online. Block 719 determines if the product ineligible for sale through the online channel or is a new product. Then the inventory protection value is set to an arbitrarily high value (e.g., 10,000 or other value above what a store would have as inventory). That way, any online order would not be routed through that facility or store. And sales of the new seasonal item (e.g., for the first 6 weeks) would not be taken from the retail.

However, if the product is not a new assortment or product or otherwise ineligible for sale through the online channel, the flow proceeds to block 726 and 729. These calculate if these multiply the previously determined inventory protection value (forecasted demand based on historical data determined in block 711) by a factor. For example, this factor can be a quantity expected next N weeks of demand divided by pass N weeks of demand.

As an example, in the case of an upcoming Black Friday, this factor will likely be greater than 1. This adjustment factor is multiplied by the forecasted demand from 711 to obtain the inventory protection value. As an further example, in the case of Black Friday having past, this factor will be likely be less than 1. This adjustment factor is multiplied by the forecasted demand from 711 to obtain the inventory protection value.

In an implementation, the inventory protection value is an integer. If the calculated value is a floating point number, then that number is rounded up to the next integer, or the floating point portion of the number is truncated (e.g., rounded down).

A pivot table is a table of grouped values that aggregates the individual items of a more extensive table (e.g., a database, spreadsheet, or business intelligence program) within one or more discrete categories. This summary might include sums, averages, or other statistics, which the pivot table groups together using a chosen aggregation function applied to the grouped values. Pivot tables are a technique in data processing. They arrange and rearrange (or “pivot”) statistics in order to draw attention to useful information. This leads to finding figures and facts quickly making them integral to data analysis. This ultimately leads to helping businesses or individuals make educated decision.

In an implementation, the search is greedy and not brute force, where the objective function (e.g., split minimization or EBIT maximization, or both) is optimized. A greedy algorithm is any algorithm that follows the problem-solving heuristic of making the locally optimal choice at each stage. In many problems, a greedy strategy does not produce an optimal solution, but, nonetheless, a greedy heuristic can yield locally optimal solutions that approximate a globally optimal solution in a reasonable amount of time.

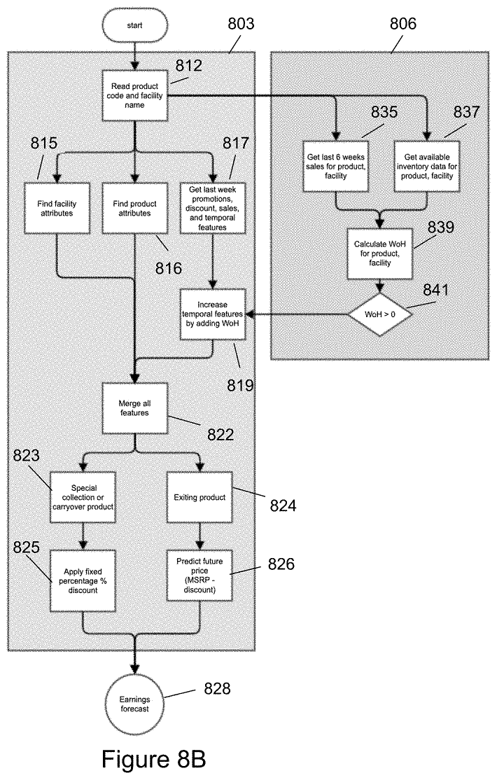

FIG. 8A shows flow of a technique of EBIT forecast optimization. In the EBIT calculation flow, there are three portions, a price prediction flow 803, a weeks on hand (WOH or WoH) or inventory flow 806, and a cross-sell opportunity flow 809. EBIT is calculated for every item present within the order. However, inventory is also a constraint. So the facilities which do not have inventory for an item are not considered for allocation for that particular item.

In other words, price prediction flow 803 calculates EBIT based futures prices, which there is a discount off manufacturer's suggested retail price (MSRP). Weeks on hand flow 806 calculates adjustments to EBIT for unproductive products. Generally, as weeks on hand increases, this will lower the future EBIT value. As weeks on hand decreases, this will increase the future EBIT value. Cross-sell opportunity flow 809 decreases the future EBIT when there is a higher likelihood of a cross-sell opportunity in a store.

In the price prediction flow, for an order, a block 812 reads a PC9 code and facility name. PC9 refers to a product code (e.g., a nine digit product code) or product identifier, each product code describing a different product model. For example, there can be the 511 jeans line in different sizes with one distressing pattern; this would be categorized under a first PC9 code. And there can be the 501 jeans line in different sizes with one distressing pattern; this would be categorized as a second PC9 code, different from the first PC9. Therefore, each PC9 code refers to a different product or product model.

Also, the code may be a PC13 code (e.g., a thirteen digit product code), which describes the product model along with the size of the product (e.g., small, medium, large). The PC system is a way to uniquely identify a product. PC9 contains the fit, wear and wash information. While PC13 includes the size. As an example, a PC9 of 055100414 is an identification code for a 510 skinny fit men's jeans item, while a PC13 of 0551004143032 is an identification code for 510 skinny fit men's jeans with waist 30 and length 32.

From block 812, the flow proceeds to a block 815 (find facility attributes), block 816 (find product attributes), and block 817 (get last week promo, mark down (MD) percentage, sales, and temp features). From block 817, the flow proceeds to a block 819 (increase temporal features by adding weeks on hand (WOH)). From blocks 815, 816, and 819, the flow proceeds to a block 822 (merge all features). After merging all the features, products are classified in to two separate categories; block 823 (special collection or carryover products, e.g., products which are going to be in next season with regular price) and block 824 (exiting products, e.g., products which will be ending at the end of current season). Carryover products receive fixed percentage of discounts chosen by business user as shown in block 825. The flow proceeds to block 826 in which gradient boosting tree based machine learning technique is applied to predict future discount. Then the earnings forecast (future EBIT) is generated in a block 827. Finally, the flow proceeds to block 828 where EBIT forecast value is increased considering cross-sell EBIT value.

In inventory flow 806, the flow proceeds from block 812 to a block 835 (get last 6 weeks sales for product, facility) and a block 837 (get inventory data for product, facility). From blocks 835 and 837, the flow proceeds to a block 839 (calculate weeks on hand for product, facility). In a decision block 841, the calculated weeks on hand can be greater than zero. This calculated weeks on hand value (e.g., greater than zero) is input to block 819. As the weeks on hand increases, this is undesirable. So, the higher the weeks on hand, this will increase the predicted future discount and respectively future EBIT value. Then, there will be more of a likelihood that the facility with greater weeks on hand of inventory of an item will be selected for shipping to the customer. This would increase the overall profitability by shipping the item from facility with higher EBIT now compared reduced future EBIT.

TABLE E

| | Present | Week | Week | Week | Week |
|---|---|---|---|---|---|
| | Week | 1 | 2 | 3 | 4 |
| Inventory | 8 | 6 | 4 | 2 | 0 |
| Average sales | 2 | 2 | 2 | 2 | 2 |
| Weeks on | 4 | 3 | 2 | 1 | 0 |
| Hand (WoH) | | | | | |

In table E, for a given product at a certain facility, block 837 (inventory data) will show current inventory at present week starting with 8 products. Block 835 obtains the last 6 seeks of sales for the product, calculating the average sales per week as 2 items per week. With a beginning product inventory of 8 items, and average sales per week as 2 items per week, block 839 calculates the weeks on hand as 4. Since the weeks on hand is greater than 0, block 841 passes on the value to block 819 as an input for future price predictions.

In cross-sell opportunity flow 809, block 815 proceeds to a block 852, cross-selling achievable margin per channel (brick and mortar mainline and outlet, and ecommerce) for products on which promotions are or will be on applied. Blocks 815 and 816 input to a block 854, get sales data for products which are or will be in promotions, per channel. From block 854, the flow proceeds to a block 856, where probability of cross selling is calculated. From blocks 852 and 856, the flow proceeds to a block 858, where cross-sell opportunity is quantified based on the cross-selling margin achievable by channel and probability of cross-selling per product per channel. Finally, a cross-sell EBIT value 860 is calculated based on cross-sell opportunity.

A cross-sell opportunity when two or more items often sell together, such as a particular pair of jeans sells well with a particular shirt. For this situation, it would be better to keep those items in the retail store, so that the cross-sell opportunity continues to exist at that store—since greater EBIT is possible with cross-selling. Finally, cross-sell EBIT value increase the forecasted (future) EBIT, and makes it less likely to ship from a facility where there is a greater cross-sell opportunity.

FIG. 8B shows an alternative flow of a technique of EBIT forecast optimization compared to FIG. 8A. In this EBIT forecast flow, there are two portions, a price prediction flow 803 and a weeks on hand (WOH) or inventory flow 806. The cross-sell opportunity flow 809 show in FIG. 8A is not considered in this alternative flow. The alternative flow in FIG. 8B may be considered where the complexity, effort, and/or resources required to implement cross-sell opportunity flow 809 in FIG. 8A does not result in significant or tangible changes in the resulting EBIT forecast 828.

TABLE F

| | | Orig- | | EBIT | EBIT | | |
|---|---|---|---|---|---|---|---|
| | RMO | inal | | Forecast | Forecast | Costs | Costs |
| | Fa- | Fa- | ECOM | (RMO | (Original | (RMO | (Original |
| | cility | cility | Price | Facility) | Facility) | Facility) | Facility) |
| Product | 812 | 810 | $68.6 | $88.20 | $88.20 | $6.71 | $11.64 |
| A | | | | | | | |
| Product | 133 | 810 | $68.6 | $24.50 | $88.20 | $6.71 | |
| B | | | | | | | |

TABLE G

| RMO EBIT | Original | Incremental |
|---|---|---|
| Total | EBIT Total | EBIT |
| $123.78 | $125.56 | −$1.78 |

TABLE H

| RMO EBIT | Original EBIT | Incremental |
|---|---|---|
| Total + | Total + EBIT | EBIT Total + |
| EBIT Forecast | Forecast | EBIT Forecast |
| Price Arbitrage | Price Arbitrage | Price Arbitrage |
| $148.28 | $86.28 | $61.92 |

Table F shows a price arbitrage opportunity identified as a result of EBIT forecast 828 generated in price prediction flow 803 in FIGS. 8A and 8B. A price arbitrage opportunity here compares the differences between the EBIT forecasted prices for the same product across two facilities, e.g., the differences in prices between predicted prices for the last units sold in two different facilities. For example, let's say product A and B in table F are ordered by a customer in a single order. The original order ships both products from facility 810, for an ECOM price of $68.60 per unit, with a cost of $5.82 per unit, and an EBIT forecast of $88.20 per unit. Utilizing the EBIT forecast, the proposed order fulfillment plan (RMO) identifies a price arbitrage opportunity by allocating an order to facility 133, where the last unit is predicted to be sold at a heavy discount.

According to the order fulfillment plan, product A ships from facility 812 for the same ECOM price of $68.60, but with a marginally higher cost at $6.71, and an EBIT forecast of $88.20. The price arbitrage opportunity is utilized when looking at product B, which has the same ECOM price of $68.60, a marginally higher cost at $6.71, and a significantly lower EBIT forecast of $24.50. The order fulfillment system processes the difference between the EBIT forecast for product B between shipping from facility 133 and facility 810. The order fulfillment system then identifies a price arbitrage opportunity of $63.70 by fulfilling the original order from facilities 133 and 812, instead of fulfilling both orders from 810 as originally planned.

Table G shows the comparison between the total EBIT profitability of the original order plan and the order fulfillment plan. The order fulfillment plan sells two items at an e-commerce (ECOM) or online price of $68.6, incurring total costs of $13.42, resulting in an EBIT of $123.78. The original order planned to sell 2 items at the same ECOM price of $68.6, incurring total costs of $11.64, resulting in an EBIT of $125.56. The order fulfillment plan incurs a higher cost and results in a decreased incremental EBIT at −$1.78. The decreased incremental EBIT will be made up by the price arbitrage opportunity identified by the order fulfillment system.

Table H shows the same total EBIT profitability shown in table G, with the addition of the price arbitrage opportunities identified by the EBIT forecasts. As presented in table F, the order fulfillment system looks at product A and predicts a decrease in price from selling now at an ECOM price of $68.60 instead of waiting to sell the same unit at a forecasted last unit sold price of $88.20, a loss of $19.6. However, for product B, the order fulfillment system identifies an increase in price from selling at an ECOM price of $68.60 instead of the forecasted last unit sold price of $24.50, an increase $44.10.

These differences in prices totaled up in table H, resulting in a total EBIT plus price arbitrage value of $148.28 for the order fulfillment plan, and a total EBIT plus price arbitrage value of $86.36 for the original order plan. The difference between the two shows a gain of $61.92, the result of the increase in price arbitrage from switching orders at $63.70 minus the decreased incremental EBIT of −$1.78 incurred from the additional costs to ship from facilities 133 and 812. If the incremental EBIT plus price arbitrage value results in a positive value, the order fulfillment system will recommend to ship from the order fulfillment plan.

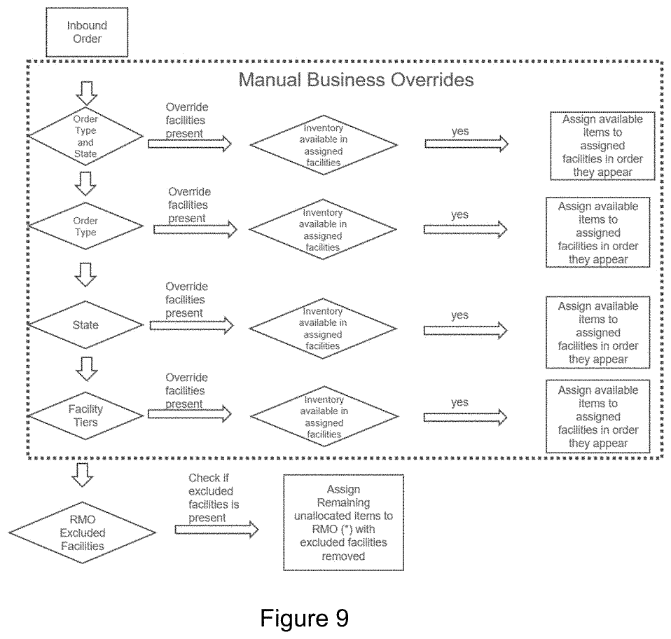

FIG. 9 shows a block diagram of manual business overrides of the order fulfillment system. For an inbound order, this is checked if an order type and state match an override situation. If so, override facilities are present. Then check if inventory is available at assigned facilities. If yes, the manual override will assign available items to assigned facilities in the order they appear.

If the order type and state do not match an override situation. Then, check the inbound order if an order type only matches an override situation. If so, override facilities are present. Then check if inventory is available at assigned facilities. If yes, the manual override will assign available items to assigned facilities in the order they appear.

If the order type only does not match an override situation. Then, check the inbound order if a state only matches an override situation. If so, override facilities are present. Then check if inventory is available at assigned facilities. If yes, the manual override will assign available items to assigned facilities in the order they appear.

If the state only does not match an override situation. Then, check the inbound order if facility tiers match an override situation. If so, override facilities are present. Then check if inventory is available at assigned facilities. If yes, the manual override will assign available items to assigned facilities in the order they appear.

If the facility tiers do not match an override situation, then proceed to check order fulfillment system (e.g., RMO) excluded facilities. Check if excluded facilities are present. If so, assign remaining unallocated items to RMO with excluded facilities removed.

A table I provide an example of a schema of a manual override feature.

TABLE I

{ “order_type_and_state”: {
“OT_Ecomm”: { “AZ”: [“810”]}
}.
“order_type”: {
“OT_DEG”: [“410”],
}.
“state”: {
“NJ”: [“810”, “811”],
}.
“facility_tiers”: {
“tier_1”: [“141”],
“tier_2”: [“125”]
}.
“rmo_excluded_facilities” : [“820”]
}

In a schema, each outer key will be checked sequentially to see if an override is present, if so:

1. Check if any of the nested keys are present in the category specified for “order type and state,” “state,” and “order type,” (for e.g. checking if the order type from the input JSON matches any of the keys specified as a manual override for order type).

2. If there is a match, then there is allocation performed for all items within the order which can be fulfilled from the facilities specified prioritized in order they appear in override. For state “810” is checked first before “811.”

3. The remaining items which cannot be fulfilled after looking at all possible applicable overrides will be routed to the system's margin optimization, excluding consideration of any facilities indicated in “rmo excluded facilities.”

4. This is kept as a config file within an S3 bucket, such as an overrides.json file.

As part of the EBIT forecast calculation, an unproductive products technique can be used. A goal is to identify where a product is selling slower relative to other locations in order to prioritize selling and clear costly inventory gluts. The unproductive products technique can be used by the order fulfillment system.

In an implementation, the technique derives average weekly sales for past 6 weeks and current available inventory derive an expected weeks on hand value as a proxy for how long that item will take to sell through. The weeks on hand (WOH or WoH)=(Current Available Inventory) divided by (Average Weekly Sellout for the past 6 weeks). In other implementations, the number of weeks can be any value w, greater than 6 or less than 6, such as 1, 2, 3, 4, 5, 7, 8, 9, 10, 11, or 12, or greater than 12.

In a further implementation, there is improved current available inventory (leveraging in-transit inventory) and forecasted sellout (leveraging factors beyond past 6 weeks of sales) to arrive at an expected weeks on hand. For example, the WOH=(Current Available Inventory+In Transit Inventory) divided by (Forecasted Weekly Sellout considering promo calendar, historical sales, and so forth).

As discussed, the EBIT or margin forecast calculation takes into consideration unproductive products. For example, unproductive products technique can compute where a product (e.g., PC9) is most “unproductive” and recommend a facility to fulfill from in an effort to optimize inventory levels.

A product will be deemed unproductive if:

1. Product in that store is not expected to clear through inventory in the next 15 weeks. For example, expected WOH is greater than 15 weeks is the lower bound.

2. Expected WOH in that store is greater than distribution center's expected WOH (combined).

3. Expected WOH in that store is greater than or equal to the seventy-fifth percentile of WOH for that product, e.g., PC9, (seventy-fifth percentile calculated on product (PC9) plus Stores where Average. Weekly Units greater than 0, before applying 15 week lower bound).

Other considerations for unproductive products include:

Unproductive products exclude markdown products, such as any products where current price is $X.98.

Expected Weeks on Hand=(Current Available Inventory)/(Average Sellout Units for past 6 weeks).

Calculated through end of prior fiscal week to protect from incomplete week's sales data skewing denominator

All tier_id=142 (SFS Elligible) stores considered.

Using past 6 weeks data (date range can be adjusted dynamically).

Excluding instances where current available inventory is under 10 units. For example, in early August, twenty-fifth percentile across dataset was 12 units.

Instances where Avg Weekly Units Sold=0 have their expected weeks on hand or WOH set to 99 weeks. If product has inventory but has not sold over the past 6 weeks, unable to calculate velocity so setting WOH as 99 weeks.

Instances where Avg Weekly Units Sold=0 and available inventory less than 15 units have expected WOH adjusted from 99 weeks to 1 week (to avoid low inventory products skewing average WOH to 99).

In a specific implementation, the order fulfillment system and flow is implemented as a linear program. Linear programming can be considered a subcategory of machine learning (ML). Linear programming (LP, also called linear optimization) is a method to achieve the best outcome (such as maximum profit or lowest cost) in a mathematical model whose requirements are represented by linear relationships. Linear programming is a special case of mathematical programming (also known as mathematical optimization).

More formally, linear programming is a technique for the optimization of a linear objective function, subject to linear equality and linear inequality constraints. Its feasible region is a convex polytope, which is a set defined as the intersection of finitely many half spaces, each of which is defined by a linear inequality. Its objective function is a real-valued affine (linear) function defined on this polyhedron. A linear programming algorithm finds a point in the polytope where this function has the smallest (or largest) value if such a point exists.

A linear program is used to maximize EBIT and minimize split shipments. EBIT can be expressed as EBIT(product)=[units(product)*price(product)]-(shipping cost+labor cost+pick-and-pack cost). Additional constraints can include one or more or a combination of the following: (i) Prioritize store for allocation if there is a markdown or near markdown event in store and it offers better EBIT now. (ii) Prioritize store for allocation (e.g., discount or promotion) if there is the product is unproductive within store and offers better EBIT now. (iii) Inventory available is above a store's inventory protection value.

The linear program can also be split into two stages, a first stage to maximize EBIT and a second stage to minimize split shipments. To maximize EBIT, see section 1 of the appendix for details. To minimize splits, see section 2 of the appendix for details.

The flows may reflect a sequence of operations. As for the mathematical operations, these operations may take place simultaneously or in parallel. In the linear programming, the optimization (e.g., maximization or minimization, or combination) of the objective function to maximize EBIT and minimize splits while also considering constraints occurs at the same time. This is why using a linear program as an optimization approach for order fulfillment is an effective technique.

Linear programming is used to ensure that the objective function—minimizing splits and maximizing EBIT is performed. This optimization excels at ensuring that all the possibilities are considered, and the best possible choice is picked. Linear programming is used to minimize splits by casting the set cover problem in mathematics (minimum number of subsets needed to cover a set) as an objective function where we look to minimize the number of stores needed to fulfill an order with a set of constraints around inventory and capacity. The system also weights the minimization of splits by EBIT to ensure that the system will pick the highest EBIT facility. Both the stores and distribution centers are considered fair candidates for allocation. The choice of stores or distribution center will be based on if the system is reducing splits or increasing EBIT, not on their status as a store or distribution center.

In an implementation, the order fulfillment system is deployed using a computing package known as Fargate, which is a compute engine available through Amazon Web Services (AWS). AWS Fargate is a serverless (cloud based) compute engine for containers that works with both Amazon Elastic Container Service (ECS) and Amazon Elastic Kubernetes Service (EKS).

Fargate allocates the right amount of compute, eliminating the need to choose instances and scale cluster capacity. Fargate only charges for the resources required to run containers, so there is no over-provisioning and paying for additional servers. Fargate runs each task or pod in its own kernel providing the tasks and pods their own isolated compute environment. This enables your application to have workload isolation and improved security by design.

Some features of the order fulfillment system include: Ability for business to add configurable rules to override logic for specific use cases. Prioritize specific facilities, exclude specific items from consideration, and others. Real time inventory. Enables higher order volume, lessens dependency on inventory protection logic. Reporting handoff. Improved unproductive inventory logic. Consolidation of two-stage optimization approach. Automated unit testing and jobs code restructure. Forecast Margin or EBIT into the future. Cross-functional effort as it impacts multiple projects. Incorporation of selling products in ecommerce which have been (or will be) on markdown (e.g., promotion) within stores into algorithm logic. Prioritize clearing inventory that will otherwise be sold at a lower price point. Enable company to measure how an allocation will impact the bottom line beyond our current implementation. Focus on long term or short term metrics (cross-functional as well). Transfer costs, EBIT realized through selling inventory that would otherwise be sold on markdown. Inventory protection logic improvements.

Further features include: Micro assortment—pass insights on inventory gluts that we observe and transfers. Replenishment Model—help prioritize the right products. Omni Channel Markdown Tool—price of products and when products will go to markdown, and unproductive products.

The order fulfillment system or ship from store system is about shipping an item from the store if the item is out of stock from the distribution center (DC). For example, a company has two distribution centers and about 300 physical retail stores in the United States from which to fulfill orders. So when an online order gets placed on the Web site, the order fulfillment system is responsible to determine from where current order needs to be fulfilled, e.g., from distribution center or from stores. Distribution centers differ from retail stores because they are typically not retail facilities. Rather they are warehouse that house inventory. The inventory at the retail stores is replaced from the distribution center. Also online orders can be fulfilled via the distribution store. Typically the amount of inventory at a distribution center is much larger than at a retail store, since distribution are much larger than retail stores (e.g., distribution has much more square footage of storage than a retail store).

In various implementations, the capacity indicates a number of orders that a retail store can handle in a day. The capacity of a retail store can be reduced by 1 when the first retail store is selected as part of an order fulfillment plan. A retail store in the first subset will not become part of the second subset when an inventory of the retail store is less than an inventory protection value of the retail store. A method can include calculating an inventory protection value based on an inventory protection logic comprising determining a forecasted unit demand based on sales at the retail store for a past period and inventory data at the store for the past period, where the sales includes retail sales at the store and online sales, and assigning the forecasted unit demand as the inventory protection value.

The inventory at a retail store can be reduced by sales of products at the store and through online sales and fulfillment. A method can include: determining an item in the order is designated as a new product, and assigning the inventory protection value to be a high value that is higher than a inventory of the product available at any of the retail stores, thereby preventing that product from being fulfilled through any retail store. A method can include: determining first component of the inventory protection value including a forecasted unit demand based on sales at the retail store for a past period and inventory data at the store for the past period, where the sales includes retail sales at the store and online sales; determining second component of the inventory protection value comprising predicted future sales data; and obtaining the inventory protection value by multiplying the first component and second component (e.g., product of the first component and second component).

In various implementations, the second location of the second retail store is physically closer to the fourth location of the customer than is the first location of the first retail store is to the fourth location of the customer. A first shipping cost to ship the first product from the first retail store is greater than a second shipping cost to ship the first product from the second retail store. The making a determination of whether the first retail store or second retail store will be used to fulfill the request for the first product or the online order includes a first stage of determining an earnings before income and taxes for the first retail store and the second retail store, and a second stage optimizing a split of fulfilling the online order using two packages.

The determining the first cost is less than the second cost, and creating a fulfillment plan where a first package will include the first product from the first retail store, and the first package will be sent to the customer to fulfill the online order is replaced by assigning a first inventory protection value to the first retail store for the first product; assigning a second inventory protection value to the second retail store for the first product; using the first inventory protection value, determining whether the first retail store has sufficient inventory to fulfill the request for the first product of the online order; and using the second inventory protection value, determining whether the second retail store has sufficient inventory to fulfill the request for the first product of the online order.

If the first product is determined to be a new product, then assigning a max value to the first inventory protection value and the second inventory protection value. Then, the request first product of the online order will not be fulfilled through the first and second retail stores, thereby reserving the first product to retail customers of the first and second retail stores. The first inventory protection value includes a first component based on historical sales and inventory data of the first store. The first inventory protection value includes a second component based on future sales data for the first product, and the second component is multiplied with the first component (e.g., product of the first and second components).

The system including: a first inventory protection value, assigned to the first retail store, where the first inventory protection value is includes a forecasted demand calculated based on sales of the first product at the first retail store for a previous period and inventory data for the first product at the first retail store for the previous period. The first inventory protection value is adjusted based on a first attribute of the first product, and when the first attribute includes that the product is a new, the previously calculated first inventory protection value is replaced with a replacement inventory protection value that is greater than the first inventory protection value.

The first inventory protection value is adjusted based on an expected future demand factor, and the previously calculated first inventory protection value is multiplied by future demand factor to obtain a second inventory protection value. The second inventory protection value can be greater than the first inventory protection value (e.g., Black Friday is coming up). The second inventory protection value can be less than the first inventory protection value (e.g., Black Friday has passed).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method comprising:
receiving an order online created by a customer at an order fulfillment server, wherein the order can be fulfilled by shipment of two or more package from a plurality of retail stores or a distribution center, or a combination;
generating an order fulfillment plan by
determining a first subset of retail stores that have a capacity to fulfill the order,
of the first subset, determining a second subset of retail stores which can fulfill an order based an inventory of the retail store and an inventory protection value for the retail store,
determining that to fulfill the order, the order will be split among the second subset of retail stores and distribution center,
for each retail store of the second subset, calculating an earnings before income and taxes (EBIT) for each item in the order;
selecting one or more retail store to fulfill the order to increase earnings before income and taxes while at the same time reducing shipping costs due to splitting the order into two or more packages; and
based on the order fulfillment plan, shipping items in the order to the customer in multiple packages, wherein at least one of a first package is from a first retail store of the retails stores and a second package is from the distribution center, or a third package is from the first retail store and a fourth package is from a second retail store.

2. The method of claim 1 wherein the capacity indicates a number of orders that a retail store can handle in a day,
reducing the capacity of the first retail store by 1 when the first retail store is selected as part of an order fulfillment plan.

3. The method of claim 1 wherein a retail store in the first subset will not become part of the second subset when an inventory of the retail store is less than an inventory protection value of the retail store.

4. The method of claim 1 comprising:
calculating an inventory protection value based on an inventory protection logic comprising
determining a forecasted unit demand based on sales at the retail store for a past period and inventory data at the store for the past period, wherein the sales includes retail sales at the store and online sales, and
assigning the forecasted unit demand as the inventory protection value.

5. The method of claim 1 wherein the inventory at a retail store can be reduced by sales of products at the store and through online sales and fulfillment.

6. The method of claim 1 comprising:
calculating an inventory protection value based on an inventory protection logic comprising
determining an item in the order is designated as a new product, and
assigning the inventory protection value to be a high value that is higher than a inventory of the product available at any of the retail stores, thereby preventing that product from being fulfilled through any retail store.

7. The method of claim 1 comprising:
calculating an inventory protection value based on an inventory protection logic comprising
determining first component of the inventory protection value comprising a forecasted unit demand based on sales at the retail store for a past period and inventory data at the store for the past period, wherein the sales includes retail sales at the store and online sales,
determining second component of the inventory protection value comprising predicted future sales data,
using as the inventory protection value a product of the first component and second component.

8. A method comprising:
providing a first pair of jeans, wherein the first pair of jeans comprises a first product;
providing a second pair of jeans, wherein the second pair of jeans comprises a first product;
providing a third pair of jeans, wherein the third pair of jeans comprises a second product;
providing a first retail store at a first location, wherein the first retail store comprises floor space designated for displaying products and selling product directly to customers who shop at the first retail store;
providing a second retail store at a second location, wherein the second retail store comprises floor space designated for displaying products and selling products directly to customers who shop at the second retail store, and the second location is different from the first location;
providing a distribution center a third location, wherein the distribution center stores products to be shipped to retail stores to replenish inventory at the retail stores and to fulfill online orders, an online order is an order that is created online, and the third location is different from the first and second locations;
receiving an online order at an order fulfillment server comprising a request for the first product and a request for the second product, wherein the online order was created by a customer at a fourth location, and the fourth location is different from the first, second, and third locations;
at the order fulfillment server, making a determination of whether the first retail store or second retail store will be used to fulfill the request for the first product of the online order, and that the distribution center will be used to fulfill the request for the second product;
determining a first cost by performing a first cost calculation of fulfilling the request for the first product of the online order via the first retail store, wherein the first cost is based on a future earnings before income and taxes and a determination is made that the first product will be sold at a discount at a time period in the future;
determining a second cost performing a second cost calculation of fulfilling the request for the first product of the online order via the first retail store, the second cost is based on a future earnings before income and taxes and a determination is made that the first product will not be sold at a discount in the time period in the future;
determining the first cost is less than the second cost, and creating a fulfillment plan where a first package will include the first product from the first retail store, and the first package will be sent to the customer to fulfill the online order, and
a second package will include the second product from the distribution center, the second package is separate from the first package, and the second package will be sent to the customer to fulfill the online order.

9. The method of claim 8 wherein the second location of the second retail store is physically closer to the fourth location of the customer than is the first location of the first retail store is to the fourth location of the customer.

10. The method of claim 8 wherein a first shipping cost to ship the first product from the first retail store is greater than a second shipping cost to ship the first product from the second retail store.

11. The method of claim 8 wherein the making a determination of whether the first retail store or second retail store will be used to fulfill the request for the first product or the online order comprises a first stage of determining an earnings before income and taxes for the first retail store and the second retail store, and a second stage optimizing a split of fulfilling the online order using two packages.

12. The method of claim 8 the determining the first cost is less than the second cost, and creating a fulfillment plan where a first package will include the first product from the first retail store, and the first package will be sent to the customer to fulfill the online order is replaced by
assigning a first inventory protection value to the first retail store for the first product;
assigning a second inventory protection value to the second retail store for the first product;
using the first inventory protection value, determining whether the first retail store has sufficient inventory to fulfill the request for the first product of the online order; and
using the second inventory protection value, determining whether the second retail store has sufficient inventory to fulfill the request for the first product of the online order.

13. The method of claim 12 wherein if the first product is determined to be a new product, then assigning a max value to the first inventory protection value and the second inventory protection value, and
the request first product of the online order will not be fulfilled through the first and second retail stores, thereby reserving the first product to retail customers of the first and second retail stores.

14. The method of claim 12 wherein the first inventory protection value comprises a first component based on historical sales and inventory data of the first store.

15. The method of claim 14 wherein the first inventory protection value comprises a second component based on future sales data for the first product, and the first inventory protection value comprises a product of the first and second components.

16. A system comprising:
a plurality of facilities available to fulfill an order comprising
a first retail store comprising a first inventory of a first product and no inventory of a second product,
a second retail store comprising a second inventory of the first product and no inventory or the second product, and
a first distribution center comprising no inventory of the first product and a first inventory of a second product;
an order fulfillment server, receiving an first order from online, wherein the first order comprises a first quantity of the first product and a second quantity of the second product, and the first order is to be fulfilled by splitting the first order across two or more facilities,
the order fulfillment server calculates a first earnings before income and taxes (EBIT) for fulfilling the first product through the first retail store,
the order fulfillment server calculates a second earnings before income and taxes (EBIT) for fulfilling the first product through the second retail store, wherein the first EBIT is greater than the second EBIT, and
the order fulfillment server fulfills the first order by routing the second quantity of the second product to the first distribution center and due to the first EBIT being greater than the second EBIT, and routing the first quantity of the first product to the first retail store instead of the second retail store.

17. The system of claim 16 comprising:
a first inventory protection value, assigned to the first retail store, wherein the first inventory protection value is comprises a forecasted demand calculated based on sales of the first product at the first retail store for a previous period and inventory data for the first product at the first retail store for the previous period.

18. The system of claim 16 wherein the first inventory protection value is adjusted based on a first attribute of the first product, and when the first attribute comprises that the product is a new, the previously calculated first inventory protection value is replaced with a replacement inventory protection value that is greater than the first inventory protection value.

19. The system of claim 16 wherein the first inventory protection value is adjusted based on an expected future demand factor, and the previously calculated first inventory protection value is multiplied by future demand factor to obtain a second inventory protection value.

20. The system of claim 19 wherein the second inventory protection value is greater than the first inventory protection value.

21. The system of claim 19 wherein the second inventory protection value is less than the first inventory protection value.
